(19) United States
(12) Patent Application Publication
(10) Pub. No.: US 2007/0007318 A1
(43) Pub. Date: Jan. 11, 2007

(54) Fastening tool set

(76) Inventor: Teng-Kuei Chen, Taipei (TW)

Correspondence Address: COOPER & DUNHAM, LLP, 1185 AVENUE OF THE AMERICAS, NEW YORK, NY, 10036, US

(21) Appl. No.: 11/174,849

(22) Filed: Jul. 5, 2005

(51) Int. Cl. B25C 5/02

(52) U.S. Cl. 227/113; 227/147

(57) ABSTRACT

A fastening tool set is used to secure fasteners to a soft and thin article and has a gripper and a die mold. The gripper has a proximal end, a distal end and a magnet mounted in the distal end. The die mold has an anvil made of rigid material and having a concave top surface. With the magnet in the gripper, the fastening tool set easily and safely fastens fasteners as thumbtacks, studs and rivets to a soft article without any injury to a user.

### BACKGROUND OF THE INVENTION

1. Field of the Invention

The present invention relates to a tool, and more particularly to a fastening tool set that easily and safely fastens fasteners such thumbtacks, studs and rivets to a soft article such as clothes, bags made of fabric or leather.

2. Description of Related Art

Thumbtacks are used generally to fasten thin articles such sheets of paper on a notice board and have an enlarged head and a spike. To fasten a sheet to the notice board, the enlarged head is pressed by a finger so that the spike penetrates the sheet and pierces the notice board. However, pressing the enlarged head may cause the spike to penetrate backward through the enlarged head and injure the finger.

Furthermore, fasteners a little similar to the thumbtacks are used in manufacture of articles such as clothes, pants and bags made of fabric or leather, and decorative fasteners such as studs and rivets are used to improve visual effect of the articles. With reference to FIGS. 8, 9, 10 and 11, a conventional fastening tool set is used to insert a fastener (70) such as a stud or rivet in thin soft articles (75) and comprises a gripper (80) and a die mold (90). The fastener (70) has a head and multiple prongs. The gripper (80) has an outer tube (81) and an inner tube. The inner tube is mounted retractably in the outer tube (81) has a bottom and a slot (82) defined in the bottom and allows the head of the fastener (70) to extend in the slot (82).

The die mold (90) has a top, an outer edge, two nipples (91) and an anvil (92). The nipples (91) extend from the outer edge and allow the fastener (70) to be attached manually to one of the nipples (91) so that the slot (82) of the inner tube of the gripper (80) can aligned with that nipple (91) and grip the fastener (70). The anvil (92) is mounted on the top of the die mold (90) and has a concave top surface. Pressing the prongs of the fastener (70) in the slot (82) of the gripper (80) against the concave top surface of the anvil (92) causes the prongs of the fastener (70) to penetrate the article (75) and bends the prongs of the fastener (70) inward to secure the fastener (70) on the article (75).

However, manually attaching the tiny fastener (70) to the nipple (91) is difficult and may injure fingers of a person.

To overcome the shortcomings, the present invention provides a fastening tool set to mitigate or obviate the aforementioned problems.

### SUMMARY OF THE INVENTION

The main objective of the invention is to provide a fastening tool set that easily and safely secures fasteners such thumbtacks, studs and rivets to soft articles such as clothes, bags made of fabric or leather.

A fastening tool set in accordance with the present invention is used to secure fasteners to a soft and thin article and has a gripper and a die mold.

The gripper has a proximal end, a distal end and a magnet mounted in the distal end.

The die mold has an anvil made of rigid material and having a concave top surface.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a gripper of a fastening tool set in accordance with the present invention;

FIG. 2 is a perspective view of a die mold of the fastening tool set in accordance with the present invention;

FIG. 3 is a side view in partial section of the gripper in FIG. 1 with fasteners;

FIG. 4 is an operational side view in partial section of the gripper in FIG. 1 and the die mold in FIG. 2 of the fastening tool set with the stud to be attached to an article made of fabric or leather;

FIG. 5 is an operational side view in partial section of the fastening tool set in FIG. 5 with the stud penetrating and fastened on the article;

FIG. 6 is an operational side view in partial section of the gripper in FIG. 1 and a die mold with another embodiment of the anvil of the fastening tool set in accordance with the present invention with the rivet to be attached to the article;

FIG. 7 is an operational view of the fastening tool set in FIG. 6 with the rivet penetrating and fastened on the article;

FIG. 8 is a perspective view of a gripper of a conventional fastening tool set in accordance with the prior art;

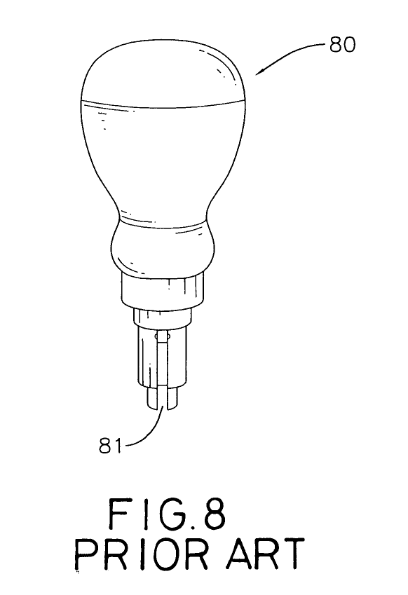

FIG. 9 is a perspective view of a die mold of the conventional fastening tool set in accordance with the prior art;

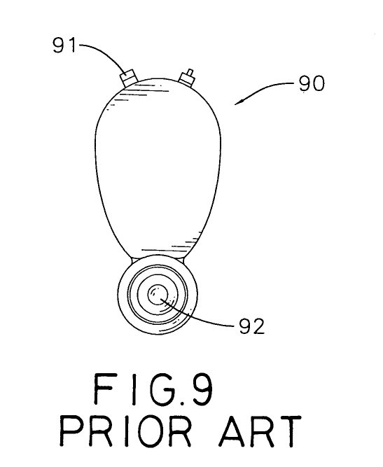

FIG. 10 is an operational perspective view of the gripper in FIG. 8 gripper a fastener on the die mold in FIG. 9 of the tool set; and

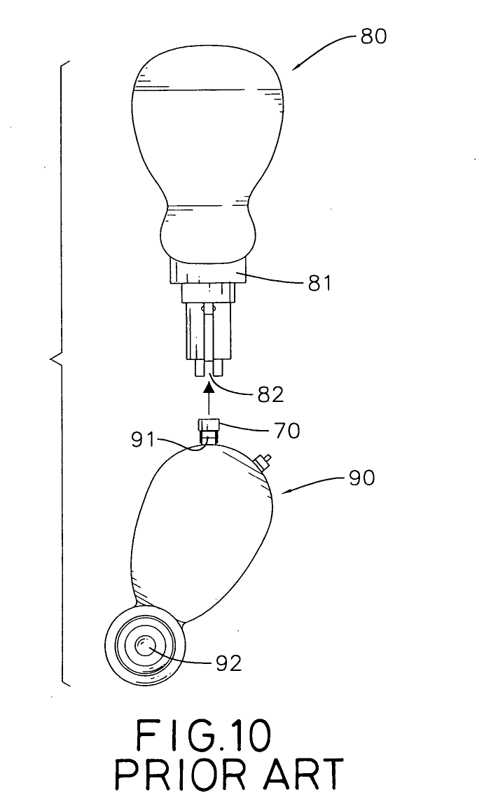

FIG. 11 is an operational perspective view of the tool set in FIG. 9 with the fastener fastened to an article made of fabric.

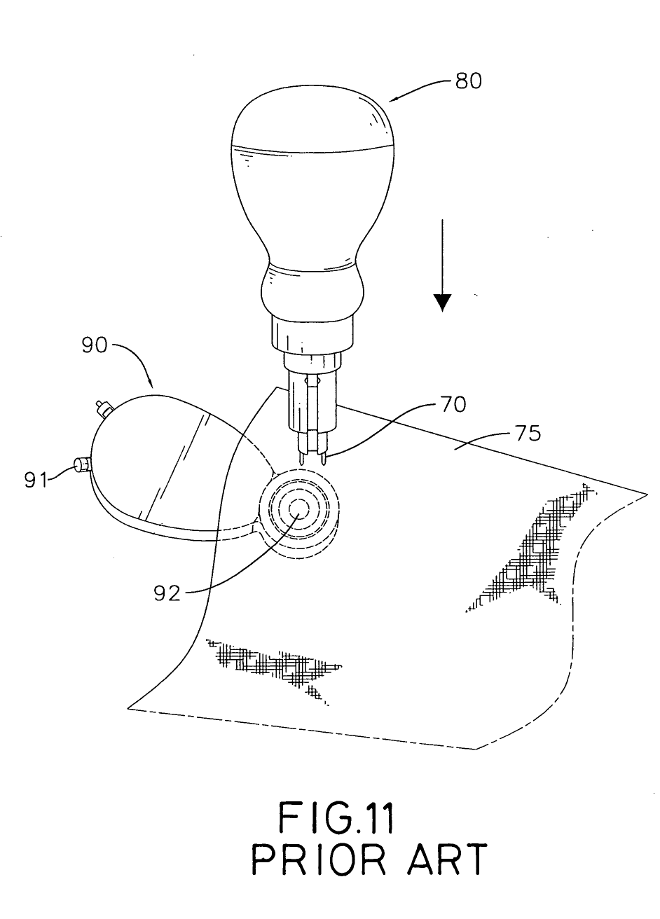

### DETAILED DESCRIPTION OF PREFERRED EMBODIMENT

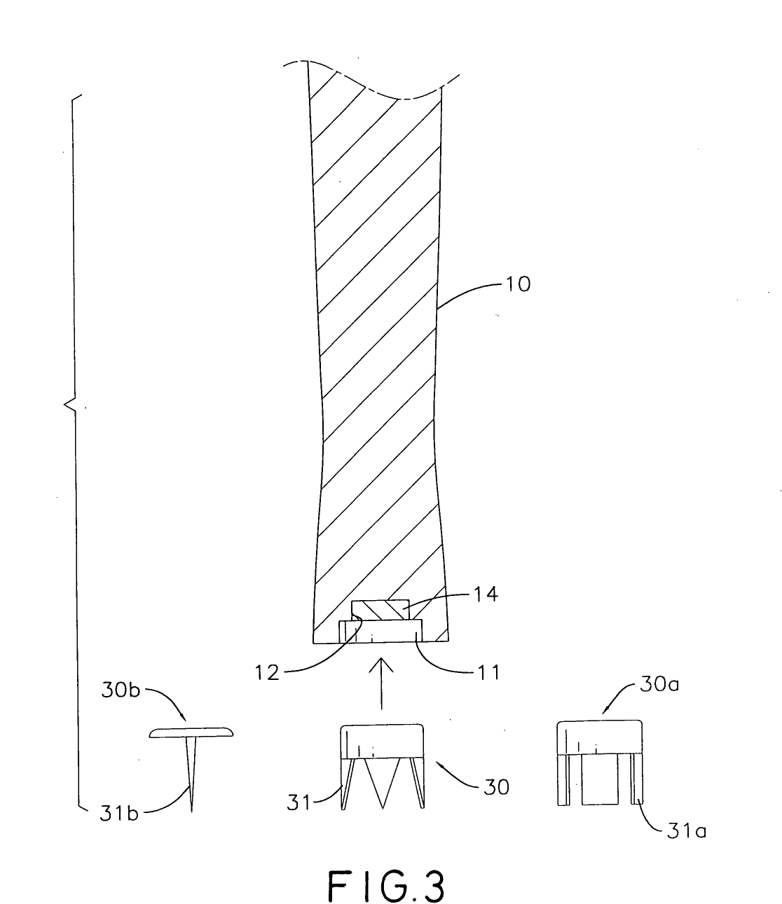

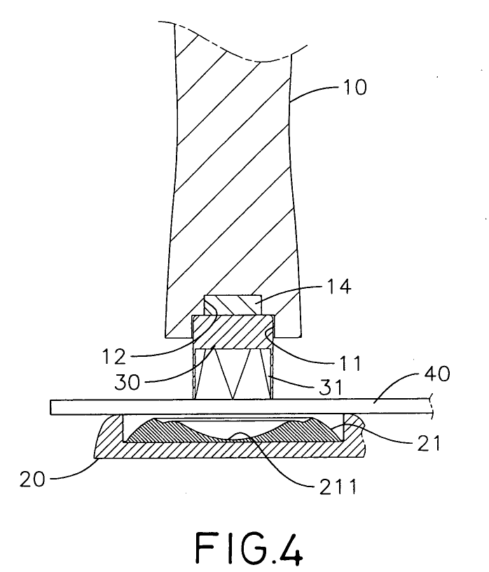

With reference to FIGS. 3 and 4, a fastening tool set in accordance with the present invention is used to secure fasteners such as thumbtacks (30b), studs (30) and rivets (30a) to a thin and soft article (40) made of fabric or leather.

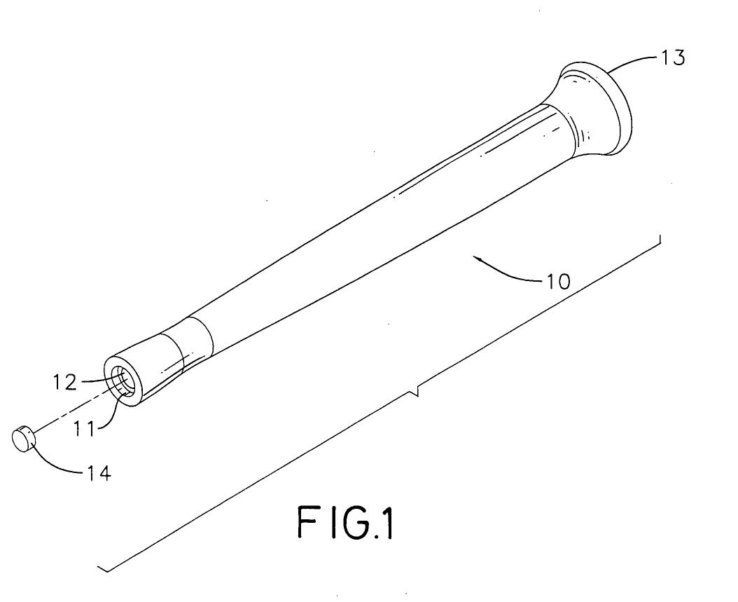

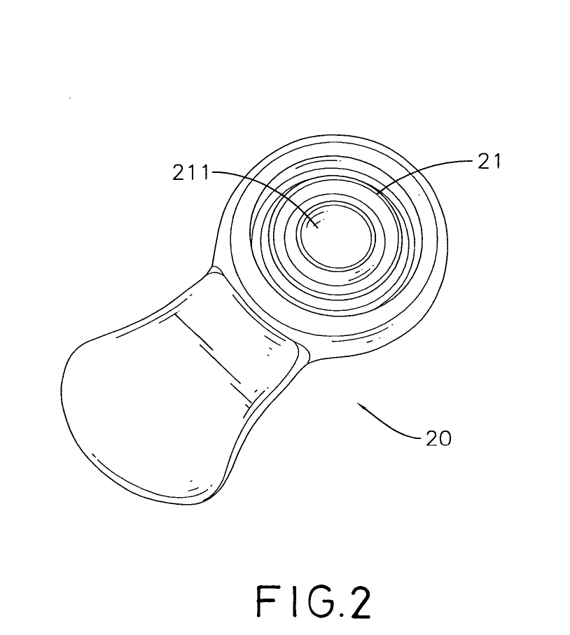

With reference to FIGS. 1 and 2, the fastening tool set comprises a gripper (10) and a die mold (20).

The gripper (10) is rod-shaped and has a proximal end, a distal end, a fastener recess (11), a mounting recess (12), an enlarged head (13) and a magnet (14).

The fastener recess (11) is defined in the distal end, has an inner surface and may receive one fastener.

The mounting recess (12) is defined in the inner surface of the fastener recess (11).

The enlarged head (13) is formed on the proximal end and has a flat end surface so that a finger or palm can easily press against the flat end surface to push the gripper (10).

The magnet (14) is securely received in the mounting recess (12). The magnet (14) in the distal end of the gripper (10) may attract one fastener mentioned above so the fastener is located in the fastener recess (11). With the thumbtack (30b) in the fastener recess (31b), pressing the enlarged head (13) on the gripper (10) can easily install a spike (31b) of the thumbtack (30b) into a notice board without any injury.

With reference to FIGS. 2, 5 and 6, the die mold (20) has a top and an anvil (21).

The anvil (21) is made of rigid material such as metal, is mounted on the top of the die mold (20) and has a concave top surface (211) and a curved protrusion (212).

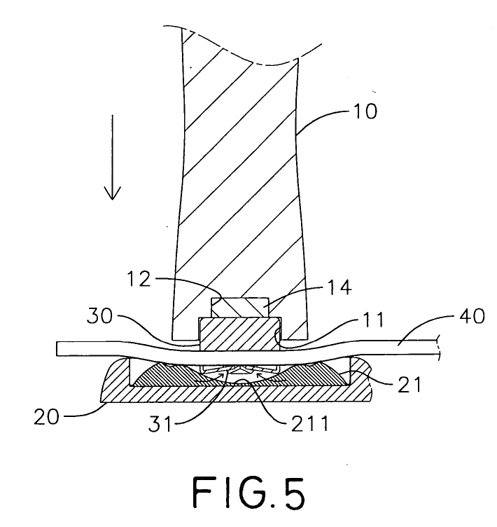

The concave top surface (211) corresponds to the distal end of the gripper (10) and may attach the fastener as the stud (30) to the article (40) by pressing the fastener in the distal end of the gripper (10) against the concave top surface (211) on which the article (40) lies. With reference to FIGS. 4 and 5, aligning the stud (30) in the fastener recess (12) in the gripper (10) with the concave top surface (211) of the anvil (21) and pressing prongs (31) of the stud (30) against the article (40) on the concave top surface (22) make the prongs (31) penetrate the article (40) and be bent inward to fasten the stud on the article (40).

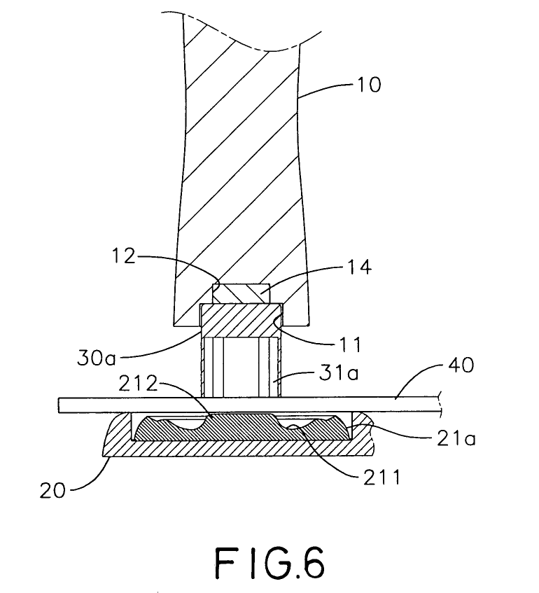

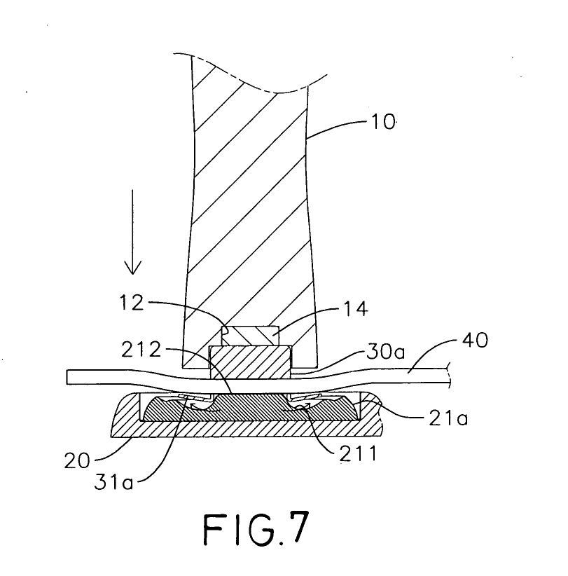

The curved protrusion (212) is formed centrally on the concave top surface (211) and has a curved annular sidewall. With reference to FIGS. 6 and 7, aligning the rivet (30a) in the gripper (10) with the curved annular sidewall of the curved protrusion (212) and pressing prongs (31a) of the rivet (30a) against the article (40) on the curved protrusion (212) make the prongs (31a) penetrate the article (40) and be bent outward to fasten the rivet (30a) on the article (40).

With the magnet (14) in the gripper (40), the fastening tool set easily and safely secures the fasteners as the thumbtacks (30b), studs (30) and rivets (30a) to the soft article (40) without any injury to a user.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A fastening tool for securing fasteners to an article, the fastening tool being a gripper comprising: a proximal end;
a distal end;
a fastener recess defined in the distal end, having an inner surface and adapted for receiving one fastener;
a mounting recess defined in the inner surface of the fastener recess; and
a magnet mounted in the mounting recess and adapted for attracting the fastener.

2. The gripper as claimed in claim 1 further comprising an enlarged head formed on the proximal end and having a flat end surface.

3. A fastening tool set for securing fasteners to a soft and thin article, comprising
a gripper having
a proximal end;
a distal end;
a fastener recess defined in the distal end, having an inner surface and adapted for receiving one fastener;
a mounting recess defined in the inner surface of the fastener recess; and
a magnet mounted in the mounting recess and adapted for attracting the fastener; and
a die mold having
a top; and
an anvil made of rigid material and having a concave top surface corresponding to the distal end of the gripper and adapted for attaching the fastener to the article by pressing the fastener in the distal end of the gripper against the concave top surface on which the article lies.

4. The fastening tool set as claimed in claim 3, wherein the gripper further has an enlarged head formed on the proximal end and having a flat end surface.

5. The fastening tool set as claimed in claim 4, wherein the anvil of the die mold further has a curved protrusion formed centrally on the concave top surface and having a curved annular sidewall.

6. The fastening tool set as claimed in claim 5, wherein the anvil is made of metal.
